(19) United States
(12) Patent Application Publication
(10) Pub. No.: US 2014/0161962 A1
(43) Pub. Date: Jun. 12, 2014

(54) PET FOOD WITH PERCEPTIBLE SHAPES

(71) Applicant: The lams Company, Cincinnati, OH (US)

(72) Inventors: Katherine P. BOEBEL, West Alexandria, OH (US); Lynnette Sue GLEADELL, Lewisburg, OH (US); Julie Marie FOY, Mason, OH (US); Rebecca Massie GREY, West Alexandria, OH (US)

(73) Assignee: The Iams Company, Cincinnati, OH (US)

(21) Appl. No.: 14/098,649

(22) Filed: Dec. 6, 2013

Related U.S. Application Data
(60) Provisional application No. 61/734,367, filed on Dec. 6, 2012.

(51) Int. Cl. A23K 1/18

(52) U.S. Cl. CPC A23K 1/1853
USPC 426/656

(57) ABSTRACT

A processed dry pet food having perceptible shapes is provided. The pet food includes a mixture of solid shaped kibble and shadow-enhancing kibble.

### FIELD OF THE INVENTION

The invention generally relates to a dry processed food, and more particularly, to a dry processed pet food with perceptible shapes.

### BACKGROUND OF THE INVENTION

Dry processed pet foods are typically formed as crunchy pieces, often in shapes and colors designed to provide an enjoyable visual experience for the consumer purchasing or serving the food. While such foods can be shaped during processing, the original color of extruded pet food is generally uniform and bland, and must be supplemented with colorants if particular colors are desired. For pet food, natural caramel color can be used to provide a brown color, but any bright colors are typically obtained via artificial colors. Even though such bright colored kibbles can be visually appealing and suggestive of meatiness or of other various ingredients, some consumers may prefer a pet food without artificial colors. Unfortunately, without artificial colorants, the kibbles can be difficult to distinguish from one another and the visual experience provided by the shape is then diminished.

As such, there remains a need for a processed pet food with perceptible shapes. There also remains a need for a processed pet food that is visually appealing without the use of artificial colors.

### SUMMARY OF THE INVENTION

A processed dry pet food having perceptible shapes is provided. The pet food includes a mixture of solid shaped kibble and shadow-enhancing kibble.

A processed dry pet food having perceptible shapes is also provided. The pet food includes a mixture of solid shaped kibble and shadow-enhancing kibble and does not include artificial colors.

Further provided is a processed dry pet food having perceptible shapes. The pet food includes a solid shaped kibble corresponding to a consumer benefit and shadow-enhancing kibble, wherein the solid shaped kibble and the shadow-enhancing kibble are substantially uniform in color.

### BRIEF DESCRIPTION OF THE DRAWINGS

FIG. 1 is a kibble mixture of two shapes.

FIG. 2 is a kibble mixture of three shapes.

### DETAILED DESCRIPTION OF THE INVENTION

Processed dry pet foods with perceptible shapes are described herein. The processed pet foods can have at least two different kibble shapes, a first shape and a second, shadow-enhancing shape. This mixture of shapes surprisingly results in improved perception of the at least two shapes, even when the kibbles are generally uniform in color.

When dry pet food is poured into the pet's bowl, it can be jumbled into a pile in varying orientations. The top layer can be primarily visible, and portions of pieces lower in the bowl may be viewable through the top layer. Because each kibble is three-dimensional, shadows form underneath and around each kibble in typical household lighting. These shadows provide some visual context to the pieces, particularly upon close inspection. Consumers who are feeding hungry pets, however, may not spend a significant amount of time viewing the kibble, and any visual impact from the design may be lost unless the pieces are contrasted in a way to make them immediately apparent upon quick inspection, such as, for example, with artificial colors.

Although the various individual kibbles each can produce shadowing, the shadow-enhancing kibble is configured to produce an additional shadow effect when the kibbles are piled together, such as in a bowl or cup. This additional shadow effect improves the perception and identification of both the shadow-enhancing kibble itself, and the other non-shadow-enhancing kibble in the mixture. While not being bound by theory, addition of the shadow-enhancing shape is thought to produce additional shadows and depth in the kibble mixture that helps give definition to the various shapes. Thus, when a consumer views a bowl of kibble containing a shadow-enhancing shape in combination with other, different shapes, the consumer can more easily perceive each shape in the mixture, even without the use of artificial colorants to highlight and contrast the individual kibbles.

The shadow-enhancing kibbles are designed with a surface that provides the enhanced shadow effect. The central aperture can protrude through the kibble from one side to the other side, or can protrude only a portion of the way through the kibble, such as, for example, about 50% or more through the kibble, about 60% or more through the kibble, about 70% or more through the kibble, or more. For example, in some embodiments, the shadow-enhancing kibbles are shapes with a central aperture surrounded by kibble, such as, for example, ring shapes, donut shapes, open heart shapes, or the like, with the central aperture providing the additional surface and shadow effect. Alternatively, in some embodiments, the shadow-enhancing kibbles are shapes such as an S shape, a C shape, a crescent shape, or the like, with an inner curved area that can provide the shadow effect.

Any desirable mixture of kibble shapes can be used in combination with the shadow-enhancing kibble. In some embodiments, each kibble can be intentionally designed to correspond to a consumer benefit, such as, for example, a shape that corresponds to emotion, such as a heart, a smile face, or a star; a shape that corresponds to the type of pet, such as a bone for a dog or a mouse for a cat; a shape that corresponds to the flavor of the food, such as a chicken drumstick, a turkey, a steak, a lamb chop, or a fish; a shape that corresponds to a specialty item or ingredient; or any other shapes that correspond to a particular consumer benefit. Mixing the intentionally designed shapes with the shadow-enhancing kibble results in perceptible shapes that can be viewed and enjoyed by the consumer as they perform the daily routine of feeding their pet.

As used herein, “pet” means dogs, cats, and/or other domesticated animals of like nutritional needs to a dog or a cat. For example, other domesticated animals of like nutritional needs to a cat may include minks and ferrets, who can survive indefinitely and heathily on a nutritional composition designed to meet the nutritional needs of cats. It will be appreciated by one of skill in the art that dogs and cats have nutritional needs which differ in key aspects. At a fundamental level, dogs are omnivores, whereas cats are obligate carnivores. Further, nutritional needs are not necessarily consistent with phylogenetic or other non-nutritional classifications.

As used herein, the term “added” refers to an ingredient or element that is supplemented in a food, and excludes endogenous sources of the ingredient or element which are added for nutritive purposes. For example, a food free of added sugars may nonetheless contain sugars that are part of other food ingredients, such as fruits, vegetables, or grains.

As used herein, the term “artificial colorant” or “artificial color” or “artificial coloring” refers to colorants that are designated as such by regulation in the United States and or the European Union, such as, for example, Blue 1, Blue 2, Citrus Red 2, Red 3, Red 40, Yellow 5, Yellow 6, and Green 3.

As used herein, unless otherwise stated for a particular parameter, the term “about” refers to a range that encompasses an industry-acceptable range for inherent variability in analyses or process controls, including sampling error. Consistent with the Model Guidance of AAFCO, inherent variability is not meant to encompass variation associated with sloppy work or deficient procedures, but, rather, to address the inherent variation associated even with good practices and techniques.

As used herein, the term “complete diet” refers a food which is a nutritionally adequate feed for an animal, is compounded to be fed as the sole ration, and is capable of maintaining life without any additional substance being consumed except water.

As used herein, the term “free of” refers to a product having less than 10 ppm of the specified element or additive, or, if the limit of detection for the specified element or additive is greater than 10 ppm, less than the limit of detection.

As used herein, “processed food” refers to a food which is significantly modified from its natural state, as by mechanical alteration (such as grinding or chopping), combination with other food products or additives, and/or cooking. As used herein, “processed food” excludes foods which substantially maintain their natural state after processing. For example, fresh produce may be washed, sorted, coated or treated, and packaged, but remain substantially in its natural state after processing, and would not be considered a “processed food” for the purpose of this disclosure.

As used herein, “typical household lighting” means lighting equivalent to the illumination of a standard 100 watt incandescent white light bulb at a distance of one meter.

Unless otherwise described, all percentages are weight percent of the food on an as-fed basis.

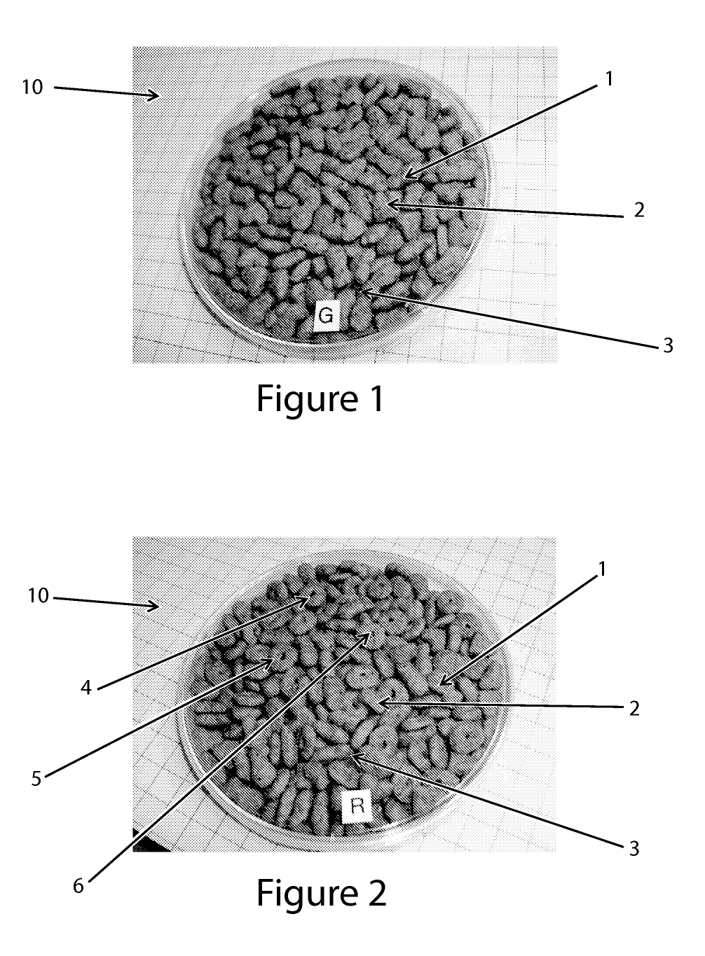

FIG. 1 shows a kibble mixture 10 of two shapes, a chicken drumstick 1 and a heart 2. The kibble mixture has shadow areas 3 around the individual pieces.

FIG. 2 shows a kibble mixture 10 of three shapes, a chicken drumstick 1, a heart 2, and a shadow-enhancing kibble 5 that has a central aperture 6. The kibble mixture has shadow areas 3, and additional shadow areas 4 that are provided by the central apertures 6.

Any number of different kibble shapes can be used in combination with the shadow-enhancing kibble, such as, for example, one, two, three, four or more different kibble shapes. In some embodiments, two different kibble shapes are used in combination with the shadow-enhancing kibble. In some embodiments, each different kibble shape can correspond to a different consumer benefit, such as, for example, a first kibble shape corresponding to an emotion and a second kibble shape corresponding to a flavor. In some embodiments, the shadow-enhancing kibble can correspond to a consumer benefit. Alternatively, in some embodiments, the shadow-enhancing kibble facilitates perception without corresponding to a consumer benefit. In some embodiments, more than one shape of shadow-enhancing kibble is used.

Any ratio of shadow-enhancing kibble to shaped kibble suitable to provide the improved perceptibility of the shapes can be used. In some embodiments, the ratio of shadow-enhancing kibble to other shapes can be about 1:1, about 1:2, about 1:3, about 1:4, or about 1:5, or any other suitable ratio. In addition, in some embodiments, the shadow-enhancing kibble can be provided in a minimum amount necessary to provide the improved perceptibility, such as, for example, less than about 50% of the kibble, less than about 45% of the kibble, less than about 40% of the kibble, less than about 35% of the kibble, less than about 30% of the kibble, less than about 25% of the kibble, less than about 20% of the kibble, less than about 15% of the kibble, or less than about 10% of the kibble.

The shaped kibble and shadow-enhancing kibble can be any suitable size. In some embodiments, the shaped kibble and the shadow-enhancing kibble can be substantially similar in size, for example, substantially similar in length and width, and/or substantially similar in thickness. Alternatively, the shaped kibble and the shadow-enhancing kibble can be different in size and/or thickness. In some embodiments, the kibble can have a width from about 5 mm to about 20 mm, such as, for example, from about 6 mm to about 18 mm, from about 7 mm to about 15 mm, or from about 9 to about 13 mm In addition, or alternatively, the kibble can have a length from about 10 mm to about 20 mm, from about 11 mm to about 19 mm, or about 13 mm to about 17 mm In some embodiments, the kibble can have a thickness from about 2 mm to about 10 mm, or about 3 mm to about 9 mm, or about 4 mm to about 8 mm

The shaped kibble can be any suitable shape, such as, for example, a cylinder, a sphere, a square, a triangle, a character, a letter, a food, or any other suitable shape. Typically, the shaped kibble is a solid, non-apertured shape.

The dry processed pet food can be prepared in any suitable means from any suitable ingredients, such as, for example, a protein source, such as a carbohydrate-rich protein source or an animal protein source, a carbohydrate source, a fat source, and any other ingredients suitable for pet nutrition.

Protein sources can be animal protein sources or carbohydrate-rich protein sources. Carbohydrate-rich protein sources will generally be of vegetable or microbial origin, and may include, for example, corn, soy, peas, other beans, cereals or legumes, yeast, algae, or combinations thereof. In contrast, most animal derived proteins, such as fish, chicken, beef, lamb, and the like, as whole products or as meal or by-product, contain relatively little carbohydrate. In some embodiments, a processed food may comprise at least 60% or at least 70% or at least 80% carbohydrate-rich protein sources. In some embodiments, a processed food may comprise protein-enriched fractions of cereals, legumes, or beans, such as corn gluten meal, corn protein concentrate, soy protein isolate, soy bean meal, soy protein concentrate, protein-rich fractions of other cereals, beans or legumes, or combinations thereof. A processed food may comprise at least 10% of a protein-enriched fraction of a cereal, legume, or bean. Even when concentrated, an enriched fraction of a cereal, legume, or bean may have higher carbohydrate content than a like weight of animal-derived protein.

The processed food may comprise a gelatinized starch matrix. The processed food may comprise less than 0.5% by weight of non-nutritive acid. The processed food may be free of non-nutritive acids. The processed food may have no added non-nutritive acids. In some embodiments, the processed food may be free of or have no added fumaric acid, lactic acid, oxalic acid, citric acid, malic acid, aspartic acid, adipic acid, ethyleneidaminetetraacetic acid (EDTA), phosphoric acid, tartaric acid, sulfuric acid, hydrochloric acid, chelating salts acidic in nature, or combinations thereof. The processed food may be free of or have no added artificial preservatives. In some embodiments, the processed food may be free of or have no added benzoates, including sodium benzoate, nitrites or nitrates, sulfites, polyphosphates, butylated hydroxyanisole or butylated hydroxytoluene (BHA/BHT), or combinations thereof.

The processed food may be free of added sugars. In some embodiments, the processed food may be free of added dextrose, fructose, fruit juice concentrate, glucose, maltose, invert sugar, malt syrup, caramel, corn syrup, high fructose corn syrup, corn syrup solids, molasses, corn sweetener, lactose, raw sugar, sucrose, sugar syrup, cane crystals, cane sugar, crystalline fructose, evaporated cane juice, and combinations thereof. In some embodiments, the processed food may comprise sources of reducing sugars to participate in Maillard Reactions, such as fruits or vegetables. The fruits or vegetables may be fresh, dried, powdered, frozen, freeze-dried, ground, or blended. Fruit or vegetable pomace may be used. Suitable fruits and vegetables include peas, spinach, tomatoes, pumpkin, blueberries, cranberries, apples, carrots, broccoli, celery, grapefruits, oranges, pears, bananas, blackberries, cantaloupe, kiwis, raspberries, strawberries, watermelon, asparagus, Brussels sprouts, cauliflower, cucumbers, green beans, sweet potatoes, potatoes, okra, apricots, mangoes, pineapples, cabbage, peaches, plums, beets, zucchini, avocados, and combinations thereof. One of ordinary skill in the art will appreciate that some parts of specific fruits or vegetables should be excluded from pet food, such as the pits or seeds of certain fruits, while other parts of the same fruit or vegetable may provide a low-fat energy source, vitamins and other nutrients, fiber, and/or reducing sugars useful in Maillard Reactions. One of ordinary skill in the art would use specific fruits and vegetables accordingly.

The processed food may be free of artificial colorants. Artificial colorants include straight colors, lakes, and mixtures prepared in accordance with the U.S. Food Drug & Cosmetic Act. These artificial colorants may be identified, for example, as FD&C Blue No. 1, or Blue 1, or Blue 1 Lake. The artificial colorants may be chemically classified as azo, xanthene, triphenylmethane, or indigoid dyes. In some embodiments, the processed food is free of artificial colorants comprising a cation reagent or substratum.

In some embodiments, a processed food may be free of added plasticizers. Plasticizers may be used to modify the texture or mouth feel of the processed food. Exemplary plasticizers include glycerin, polyols such as propylene glycol and butylene glycol, polyhydric glycols such as glycerol and sorbitol, and the like, as well as some gums (such as carboxymethyl cellulose) and proteins (such as gelatin) and combinations thereof. Several of these plasticizers have no distinct aroma, and the mechanism by which the plasticizer seems to exacerbate the sour or fermented smell associated with other additives is not fully understood. Some plasticizers also serve as humectants, and, without wishing to be bound by theory, it is speculated that the changes in texture and/or moisture content associated with a plasticizer may retard the dissipation of volatile components of other additives and prolong the duration of a sour or fermented smell created primarily by other additives. The possibility of a chemical reaction between plasticizers and other additives has not been ruled out.

In some embodiments, it may be desirable to enhance the content of anti-oxidants in the food. For example, it may be desirable to compound the food to provide increased levels of Vitamin E (or mixed tocopherols), Vitamin C, carotenoids, polyphenols, modified or derived forms thereof, or combinations of these. These compounds may serve a dual purpose. They may be nutritionally relevant to a human or animal who consumes the food, and may prevent or reduce oxidation of the food over time. These anti-oxidants may be manipulated by compounding the food to include natural sources of these compounds, such as selected fats, fruits, vegetables, or may be added separately to the food as a supplement. In some embodiments, the food has a Vitamin E content of at least 80 IU/Kg of food, or at least 150 IU/Kg of food, or at least 250 IU/Kg of food, or at least 500 IU/Kg of food. In some embodiments, the food has a Vitamin C content of at least 10 ppm, or at least 25 ppm, or at least 50 ppm, or at least 100 ppm. By way of comparison, the 2012 AAFCO Dog Food Nutrient Profile recites a minimum Vitamin E content of 50 IU/Kg (on a dry matter basis), and the 2012 AAFCO Cat Food Nutrient Profile recites a minimum Vitamin E content of 30 IU/Kg (on a dry matter basis). The 2012 AAFCO Nutrient Profiles for Dogs and Cats do not identify Vitamin C as a required nutrient. The higher Vitamin E level may be used with or in lieu of the Vitamin C. The Vitamin C may be used with or in lieu of the Vitamin E level. Carotenoids, polyphenols, and/or other nutritive anti-oxidants may be used with or in lieu of Vitamins E and/or C. Higher anti-oxidant content in the food may delay, reduce, or prevent oxidation, and, therefore, may help reduce or prevent the formation of aldehydes over time, which may negatively impact the aroma profile of the food.

In some embodiments, the processed food may comprise less than 10%, or less than 5%, or less than 3%, of rendered products of bovine or porcine origin. These products, including isolated fats of bovine or porcine origin, may contribute to fecal tones in the aroma of the food which can detract from or even overwhelm the grainy, toasty aroma associated with carbohydrate-rich protein sources. Rendered products can be distinguished from meat products, including unmodified or whole cuts of beef or pork, ground beef or pork, or shredded beef or pork. Dried meat or dried meat by-product meals may also have a less offensive odor than rendered products.

In some embodiments, the processed food may have a pleasant aroma. The processed food may be prepared using any suitable method for initiating Maillard Reactions, such as extrusion cooking, baking, ohmic heating, retorting, and the like. The food may be coated after cooking, as with a glaze, fat, palatant, or other additions. In some embodiments, any coating or addition after the food is cooked is substantially free of animal digest or animal by-product, i.e., any coating or addition after the food is cooked comprises less than 50% by weight of the coating or addition animal digest or animal by-product. In some embodiments, any coating or addition after the food is cooked comprises less than 5% by weight of the coated or finished food animal digest or animal by-product. The food may be a dry food, having a moisture content of less than or equal to 12%. The food may be intended for human ingestion, such as breakfast cereal, snack bars, snack chips or crisps, and the like. The food may be intended for ingestion by a pet. The food may be a dog food or a cat food. The food may be a complete diet for a companion animal. The food may be a treat, a food product intended for use with a complete diet for the purpose of enjoyment or reward. The food may be a supplement, a food product intended for use with a complete diet for the purpose of providing non-essential nutrients or substances such as medications, or for providing enhanced quantities of essential nutrients beyond the minimum levels required in a complete diet.

### Example A

Two kibble shapes, generally in the form of a drumstick and a heart, were mixed in a bowl. The kibbles were produced from the same food composition, and had no significant difference in color, texture, or visible surface features (e.g., striation, coatings, sprinkles, or seasonings) other than the shape of the kibble. When presented to prospective consumers, consumers ranked this mix of shapes an average 5.95 on a scale of 1-9 for variety.

### Example B

Ring-shaped kibble were placed in a bowl with no other shapes. The kibbles were produced from the same food composition, and had no significant difference in color, texture, or visible surface features (e.g., striation, coatings, sprinkles, or seasonings). When presented to prospective consumers, consumers ranked this mix of shapes an average 4.45 on a scale of 1-9 for variety.

### Example C

Three kibble shapes, generally in the form of a drumstick, a heart, and a ring, were mixed in a bowl. The kibbles were produced from the same food composition, and had no significant difference in color, texture, or visible surface features (e.g., striation, coatings, sprinkles, or seasonings) other than the shape of the kibble. When presented to prospective consumers, consumers ranked this mix of shapes an average 6.35 on a scale of 1-9 for variety.

### Example D

Prospective consumers are presented a mixture of bright, multi-colored kibble (i.e., comprising different kibble pieces of different colors), and the mixture of Example C, and asked to rank their perceptions of the kibble as “natural” and “healthy” on a scale of 1-9. The multi-colored kibble was ranked and average 3.95 for natural and 5.25 for healthy. The mixture of Example C was ranked 6.15 for natural and 6.16 for healthy.

Examples A-D tend to show that the inclusion of a kibble shape having a shadow area, such as a ring, in a mixture of kibbles improves the perception of variety in the kibble without the need for artificial colorants or other visual signals that may provide a perception that a food is less natural or less healthy than a food without artificial colorants or other additives used as visual signals.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A processed dry pet food having perceptible shapes, the pet food comprising a mixture of solid shaped kibble and shadow-enhancing kibble.

2. The pet food of claim 1, wherein the shadow-enhancing kibble has a central aperture.

3. The pet food of claim 1, wherein the shadow-enhancing kibble is a ring shape, a donut shape, an open heart shape, an S shape, a C shape, or a crescent shape.

4. The pet food of claim 1, wherein the shadow-enhancing kibble comprises less than about 50% of the kibble.

5. The pet food of claim 1, wherein the shadow-enhancing kibble comprises less than about 25% of the kibble.

6. The pet food of claim 1, wherein the shaped kibble is a heart shape.

7. The pet food of claim 1, wherein the shaped kibble is a flavor shape selected from the group consisting of a drumstick, a turkey, a fish, a lamb chop, and a steak.

8. A processed dry pet food having perceptible shapes, the pet food comprising a mixture of solid shaped kibble and shadow-enhancing kibble, wherein the pet food does not include artificial colors.

9. The pet food of claim 8, wherein the shadow-enhancing kibble has a central aperture.

10. The pet food of claim 8, wherein the shadow-enhancing kibble is a ring shape, a donut shape, an open heart shape, an S shape, a C shape, or a crescent shape.

11. The pet food of claim 8, wherein the shadow-enhancing kibble comprises less than about 50% of the kibble.

12. The pet food of claim 8, wherein the shadow-enhancing kibble comprises less than about 25% of the kibble.

13. The pet food of claim 8, wherein the shaped kibble is a heart shape.

14. The pet food of claim 8, wherein the shaped kibble is a flavor shape.

15. A processed dry pet food having perceptible shapes, the pet food comprising a solid shaped kibble corresponding to a consumer benefit and shadow-enhancing kibble, wherein the solid shaped kibble and the shadow-enhancing kibble are substantially uniform in color.

16. The pet food of claim 15, wherein the shadow-enhancing kibble has a central aperture.

17. The pet food of claim 15, wherein the shadow-enhancing kibble comprises less than about 50% of the kibble.

18. The pet food of claim 15, wherein the consumer benefit is emotion and the shaped kibble is a heart shape, a smile face, or a star.

19. The pet food of claim 15, wherein the consumer benefit is flavor and the shaped kibble is a chicken drumstick, a turkey, a steak, a lamb chop or a fish.

20. The pet food of claim 15, wherein the consumer benefit is the type of pet and the shaped kibble is a bone or a fish.
